(19) United States
(12) Patent Application Publication
(10) Pub. No.: US 2009/0308541 A1
(43) Pub. Date: Dec. 17, 2009

(54) Non-glue based moistorizing device

(76) Inventor: Mina Houtan, Egg Harbor Twp., NJ (US)

Correspondence Address: Mina Houtan, Ph.D., 300 Central Avenue, Egg Harbor Township, NJ, 08234, US

(21) Appl. No.: 12/157,731

(22) Filed: Jun. 13, 2008

(51) Int. Cl. B65C 11/04

(52) U.S. Cl. 156/578

(57) ABSTRACT

A non-glue based moisturizing device for moistening surfaces that are pre-coated with a dry adhesive. The moisturizing device of this improved invention includes a body that is flat on four sides that stores an aqueous solution, a roller tip capable of dispensing a measured amount of aqueous solution to the pre-coated adhesive surface of the object without the need of licking the object with the tongue. It has a cap that snaps on to protect the tip and prevent leakage when not in use. The aqueous solution contains water as the major constituent, does not contain colorants, and has a viscosity greater than water.

### BACKGROUND OF THE INVENTION

1. Field of the invention

This invention relates to the field of stationeries. Specifically, this invention relates to non-glue based moisturizing devices for moistening objects that are pre-treated with adhesive compounds.

2. Background Art

Numerous devices are described in the prior art that purport to apply adhesive or non-adhesive compounds to a variety of objects. Generally these devices include a housing to store the compound and a tip properly designed to apply the compounds to different surfaces.

Most of the prior art devices use sponge tips which shred over a period of time or they use a dapper tip which becomes very wet; spreading this wetness over all of the object you are moistening. This improved invention offers a roller tip which does not have the aforementioned drawbacks, is efficient, easy to use and inexpensive.

### BRIEF SUMMARY OF THE INVENTION

This improved invention of a non-glue based moisturizing device features a hand-held device with a roll-on moisturizing tip; allowing the user to moisten an object, such as envelopes, stamps, or labels that are pre-treated with a dry adhesive without the need lick the object with their tongue, but instead roll moisture directly onto the object with ease and precision.

### BRIEF DESCRIPTION OF THE DRAWINGS

FIG: 1 The device, which is translucent and rectangular shaped with a flat bottom for stability. The device measures 13 cm in length and is of molded plastic. The front view measures 20 mm in width.

FIG: 1a The collar of the device measures 15 mm from the top of the collar to 16 mm at the base of the collar so that the roller snaps inside tightly into the small openings, yet moves freely as it is used, dispensing a controlled measure of fluid.

FIG: 2 Side view measures 10 mm in width.

FIG: 2a Opening which allows the roller to be snapped into place.

FIG: 3 Roller which is of molded plastic measuring 16 mm with tabs on each end.

FIG: 4 Push cap measures approximately 15 mm. Will snap onto the collar of the device.

### DETAILED DESCRIPTION OF THE INVENTION

The advantages and features of this present invention will be more fully appreciated through the following detailed description. This invention is of an improved method of applying moisture to an object such as envelopes, stamps, and labels that are pre-treated with a dry adhesive. Self-sealing envelopes are coated with a wet adhesive and would seal without the need for moisture, however, the price of the self-sealing envelopes is twice as much as the dry coated adhesive envelopes.

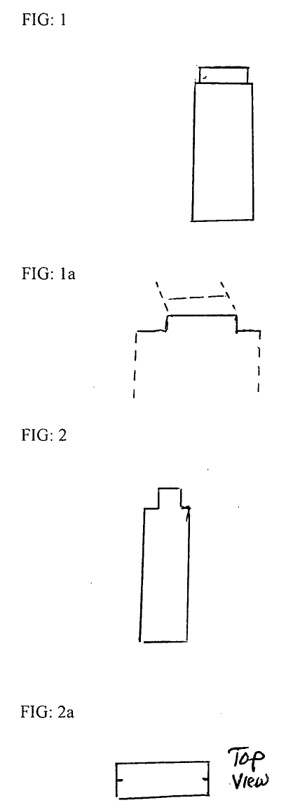

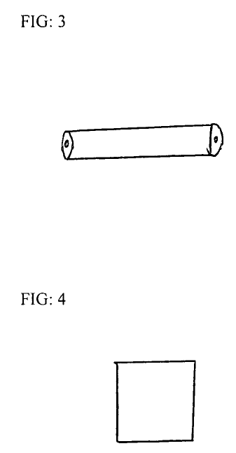

Accordingly, the novel moisturizing device of this improved invention is economically and practically attractive to the majority of businesses and private activities that send out vast amounts of mail daily. Referring to FIG. 1, the device is triangular in shape, no larger than a highlighter marker, with 4 flat sides and a flat bottom for stability. It features a roller tip as identified in FIG. 3, which allows the user to moisten an object pre-treated with a dry adhesive, with ease and precision and without mess. The roller measures 10 mm in width and 16 mm in length and has snap on tabs on both ends to easily snap into the collar cavity. The body and cap are made of molded plastic that is transparent, and can be tinted with color to simulate the appearance of a highlighter giving it an attractive appearance. The cap as identified in FIG. 4 will snap into the collar to protect the tip and to prevent leakage during non-use. The body of the device is filled with an aqueous solution.

The aqueous solution contains water as a major constituent, and does not contain colorants. The viscosity of the aqueous solution is preferably greater than water. The water content is about 99% tap water with minor constituents such as inorganic materials bactericidal, ions, a dry substance, among others. Some examples of water soluble polymers are ones that are made by The Dow Chemical Company®; METHOCEL, premium methylcellulose and hypromellose products, and POLYOX, water-soluble resins, NF grade. During its use, the device will dispense a measured amount of moisturizing fluid to the object with dry adhesive eliminating the need to lick the object with the tongue. Because of the viscosity of the moisturizing agent, there will be no mess or drip.

1. An improved moisturizing device for moistening a paper object that is pre-treated with a dry adhesive. It is rectangular in shape, making it easy to hold It features a roller tip. It is hand held with four flat sides and a flat bottom. It has a snap-on cap for protecting the roller tip and to prevent spillage.

2. The moisturizing device of claim 1 has a roller that snaps into the collar for a snug fit, yet allows the roller to move freely within the collar.
